(19) United States
(12) Patent Application Publication
(10) Pub. No.: US 2013/0178180 A1
(43) Pub. Date: Jul. 11, 2013

(54) FRONT END MODULE

(71) Applicant: Taiyo Yuden Co., LTD., Tokyo (JP)

(72) Inventors: Shinpei Oshima, Tokyo (JP); Hitoshi Ebihara, Tokyo (JP)

(73) Assignee: Taiyo Yuden Co., Ltd., Tokyo (JP)

(21) Appl. No.: 13/667,051

(22) Filed: Nov. 2, 2012

(30) Foreign Application Priority Data
Nov. 11, 2011 (JP) 2011-247287

(51) Int. Cl. H04B 1/16

(52) U.S. Cl. CPC H04B 1/16
USPC 455/188.1

(57) ABSTRACT

Provided is a front end module which is provided with an output terminal shared in a plurality of frequency bands and in which insertion losses are suppressed. A front end module in an embodiment includes an antenna terminal, an output terminal, and a switch for selectively connecting the antenna terminal to a first band pass filter configured to cause a signal of a first pass band to pass therethrough or a second band pass filter configured to cause a signal of a second pass band, which is different from the first pass band, to pass therethrough. The front end module may include a phase shifter arranged between the switch and the first band pass filter.

### CROSS-REFERENCE TO RELATED APPLICATIONS

This application claims priority from Japanese Patent Application No. 2011-247287, filed Nov. 11, 2011, which is hereby incorporated herein by reference in its entirety.

### FIELD OF THE INVENTION

The present invention relates to a front end module and, more particularly, to a front end module used in a communication device supporting multi band.

### RELATED ART

Cellular phones supporting multiband which are capable of performing intercommunication and transmitting and receiving of data using a plurality of communication methods have been in widespread use. In general, such a cellular phone is provided with a front end module in which an RF circuit composed of a high-frequency switch, a filter, an amplifier element and the like is combined into a single unit, and this front end module separates a received multiband signal in which signals of a plurality of frequency bands are superimposed for each frequency band, and outputs the received multiband signal to a rear end receiver.

There are examples of disclosure of a front end module in which an output terminal is shared by a plurality of frequency bands in order to miniaturize a front end module in which an amplifier element is shared by a plurality of frequency bands. For example, Japanese Patent Laid-Open No. 2005-64778 discloses a front end module which is configured in such a manner that a set of band pass filters using frequency bands which are different from each other as pass bands are arranged in parallel between a common input terminal and a common output terminal, and a switch is connected to each of the input side and output side of this set of the band pass filters (see FIG. 8-B of Japanese Patent Laid-Open No. 2005-64778).

### CITATION LIST

### Patent Literature

Patent Literature 1: Japanese Patent Laid-Open No. 2005-64778

In the front end module described in Japanese Patent Laid-Open No. 2005-64778 a switch is provided in each of the input side and output side of a filter and, therefore, each time a received signal passes through this filter, the received signal is attenuated, with the result that insertion losses of the module increase. Therefore, a front end module which is provided with an output terminal shared by a plurality of frequency bands and hence insertion losses are suppressed is provided by various embodiments of the present invention. Other problems will be understood from the following detailed description and entries of the accompanying drawings and the like.

### SUMMARY

A front end module in an embodiment of the present invention is provided with an antenna terminal to which a received signal from at least an antenna is inputted, an output terminal, a switch which has a first terminal, a second terminal, and a third terminal, is connected to the above-described antenna terminal via the above-described first terminal, and selectively connects the above-described first terminal to the above-described second terminal or the above-described third terminal, a first transmission channel which transmits the above-described received signal between the above-described second terminal and the above-described output terminal, a second transmission channel which transmits the above-described received signal between the above-described third terminal and the above-described output terminal, a first filter which is provided on the above-described first transmission channel and causes a signal of a first pass band in the above-described received signal to pass therethrough, a second filter which is provided on the above-described second transmission channel and causes a signal of a second pass band, which is different from the above-described first pass band, in the above-described received signal to pass therethrough, a matching circuit which is arranged between the above-described first and second filters and the above-described output terminal, and a first phase shifter which is arranged between the above-described second terminal and the above-described first filter.

According to the various embodiments of the present invention, it is possible to provide a front end module which is provided with an output terminal shared by a plurality of frequency bands and hence insertion losses are suppressed.

### BRIEF DESCRIPTION OF THE DRAWINGS

FIG. 1 is a circuit diagram showing a front end module in an embodiment of the present invention;

FIG. 2A is a Smith chart showing the frequency characteristics of an input impedance of a circuit on a band pass filter 24 without the phase shifter 22 side as viewed from a second terminal 18;

FIG. 2B is a Smith chart showing the frequency characteristics of an input impedance of a circuit on a band pass filter 24 side as viewed from a second terminal 18;

FIG. 3 is a graph showing the attenuation characteristics of a front end module in an embodiment of the present invention during an action of the band pass filter 24;

FIG. 4 is a graph showing the attenuation characteristics of a front end module provided with no phase shifter; and

FIG. 5 is a graph showing the attenuation characteristics of a front end module in an embodiment of the present invention during an action of a band pass filter 26.

### DETAILED DESCRIPTION OF THE PREFERRED EMBODIMENTS

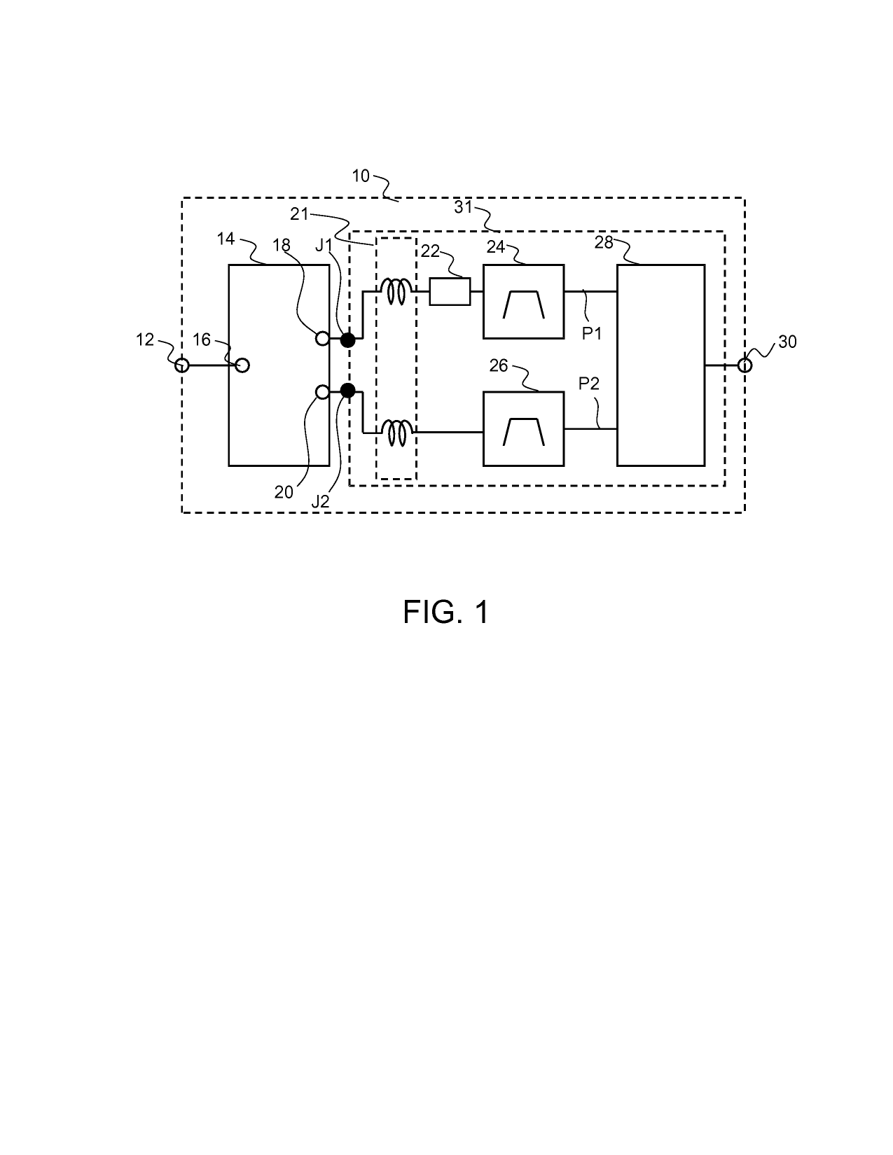

Various embodiments of the present invention will be described with reference to the accompanying drawings. FIG. 1 is a circuit diagram showing a front end module 10 in an embodiment of the present invention. As shown in the figure, the front end module 10 in an embodiment of the present invention is provided with a switch 14 which is connected to an antenna terminal 12, band pass filters 24, 26 which are connected to the rear end of the switch 14 via a switch matching circuit 21, a matching circuit 28 connected to the output side of the band pass filters 24, 26, and an output terminal 30. A multiband signal inputted from an antenna, which is not shown, via the antenna terminal 12 is selectively transmitted to either of the band pass filters 24, 26 according to the switching action of the switch 14. Each of the band pass filters 24, 26 causes a signal of each pass band in the signal from the switch 14 to pass therethrough. A signal which has passed through the band pass filters 24, 26 is outputted to the rear end receiver from the output terminal 30. In an embodiment, a phase shifter 22, which will be described later, is arranged between the band pass filter 24 and the switch 14. A switch matching circuit 21 in an embodiment includes a plurality of inductors connected to a terminal of the switch 14.

The switch 14 in an embodiment is, for example, an SPDT (single pole dual throw) type switch provided with a first terminal 16, a second terminal 18, and a third terminal 20, connected to the antenna terminal 12. The switch 14 is further provided with a voltage supply terminal for supplying voltage (not shown) and a control terminal for inputting control signals (not shown), and is configured in such a manner that the first terminal 16 is selectively connected to either the second terminal 18 or the third terminal 20 on the basis of a control signal inputted from this control terminal. It is possible to set the number of terminals of the switch 14 arbitrarily according to the circuit configuration. For example, the switch 14 can be an SP3T switch, an SP4T switch, an SP8T switch, a DPDT switch or a DP4T switch. For example, a field-effect transistor can be used as a switch element configuring the switch 14.

The band pass filter 24 is arranged on a first transmission channel P1 which connects the second terminal 18 of the switch 14 and the output terminal 30. Furthermore, the band pass filter 26 is arranged on a second transmission channel P2 which connects the third terminal 20 of the switch 14 and the output terminal 30. The band pass filters 24, 26 are composed of, for example, a surface acoustic wave filter (an SAW filter) or a bulk acoustic wave filter (a BAW filter). The band pass filters 24, 26 have each a pass band which is unique to each, and the band pass filters transmit a signal of the pass band in the inputted signal to a rear end circuit and suppress signals other than the pass band. The pass bands of the band pass filters 24, 26 are set to receiving bands of various bands specified in, for example, the UMTS (Universal Mobile Telecommunications System). The band pass filters 24, 26 may be configured in such a manner as to output an inputted unbalanced signal after conversion to a balanced signal.

The matching circuit 28 is arranged between the band pass filters 24, 26 and the output terminal 30. The matching circuit 28 can be configured by combining receiving elements, for example, a capacitor and an inductor. The matching circuit 28 is configured in such a manner that the input impedance of the front end module 10 as viewed from the antenna side and the output side is matched to an outer circuit connected to the rear end of the output terminal 30 in the pass bands of the band pass filters 24, 26. That is, the configuration is such that the input impedance of the front end module 10 matches with a standard impedance in the pass band of the band pass filter 24 in the case where the band pass filter 24 is brought into action by connecting the first terminal 16 of the switch 14 to the second terminal 18 and that the input impedance of the front end module 10 matches with a standard impedance in the pass band of the band pass filter 26 in the case where the band pass filter 26 is brought into action by connecting the first terminal 16 of the switch 14 to the third terminal 20. Because a specific configuration method of the matching circuit 28 which satisfies such matching conditions is obvious to those skilled in the art, a detailed description thereof is omitted in this specification.

In this manner, the matching circuit 28 is provided in the rear end of the band pass filters 24, 26, and via this matching circuit 28 the band pass filters 24, 26 are connected to the common output terminal 30, whereby it is possible to suppress insertion losses compared to a conventional front end module (refer to FIG. 8-B of Japanese Patent Laid-Open No. 2005-64778) in which a switch is provided at the rear end of the band pass filters 24, 26.

On the other hand, because in the front end module 10 in an embodiment of the present invention, the output sides of the band pass filters 24, 26 are constantly connected by the matching circuit 28, the isolation between the band pass filter 24 and the band pass filter 26 becomes insufficient, and when one of the filters is brought into action, due to the influence of the other filter, the attenuation characteristics of the filter which becomes the object of the action may deteriorate. For example, in the case where the band pass filter 24 is brought into action by connecting the first terminal 16 of the switch 14 to the second terminal 18, a signal of the pass band of the band pass filter 26 leaks a little to the third terminal 20, which is essentially disconnected from the first terminal 16 and the second terminal 18, with the result that this leakage signal passes through the band pass filter 26 and reaches the output terminal 30, whereby the attenuation characteristics of the front end module 10 during the action of the band pass filter 24 may deteriorate in the pass band of the band pass filter 26, which is essentially disconnected.

Therefore, in an embodiment of the present invention, the phase shifter 22 is arranged between the second terminal 18 of the switch 14 and the band pass filter 24, whereby the input impedance of a circuit 31 as a single unit which is connected to the rear (output side) of the switch 14 as viewed from a connection point J1 between the circuit 31 and the second terminal is made substantially zero in the pass band of the band pass filter 26. As a result of this, it is possible to suppress the deterioration of the attenuation characteristics in the pass band of the band pass filter 26. In this manner, by making the input impedance of the circuit 31 as a single unit as viewed from the connection point J1 substantially zero in the pass band of the band pass filter 26, it is possible to suppress the leakage of a signal in the pass band of the band pass filter 26 from the first terminal 16 and the second terminal 18 to the third terminal 20 and as a result, it is possible to suppress the deterioration of the attenuation characteristics in the pass band of the band pass filter 26. In an embodiment, the switch matching circuit 21, the phase shifter 22, the band pass filter 24, the band pass filter 26, and the matching circuit 28 are included in the circuit 31, which becomes an object of adjustment of input impedance, but it is possible to cause various elements other than these elements to be included in the circuit 31. The specific configuration of the circuit 31 described here is illustrative only, and it is possible to cause various elements other than those described specifically in this specification to be included in the circuit 31. That is, the circuit 31 is an arbitrary circuit arranged between the switch 14 and the output terminal 30. As will be described later, the input impedance of the circuit 31 is evaluated as the circuit 31 as a single unit, i.e., in a condition in which the switch 14 does not substantially affect the impedance of the circuit 31.

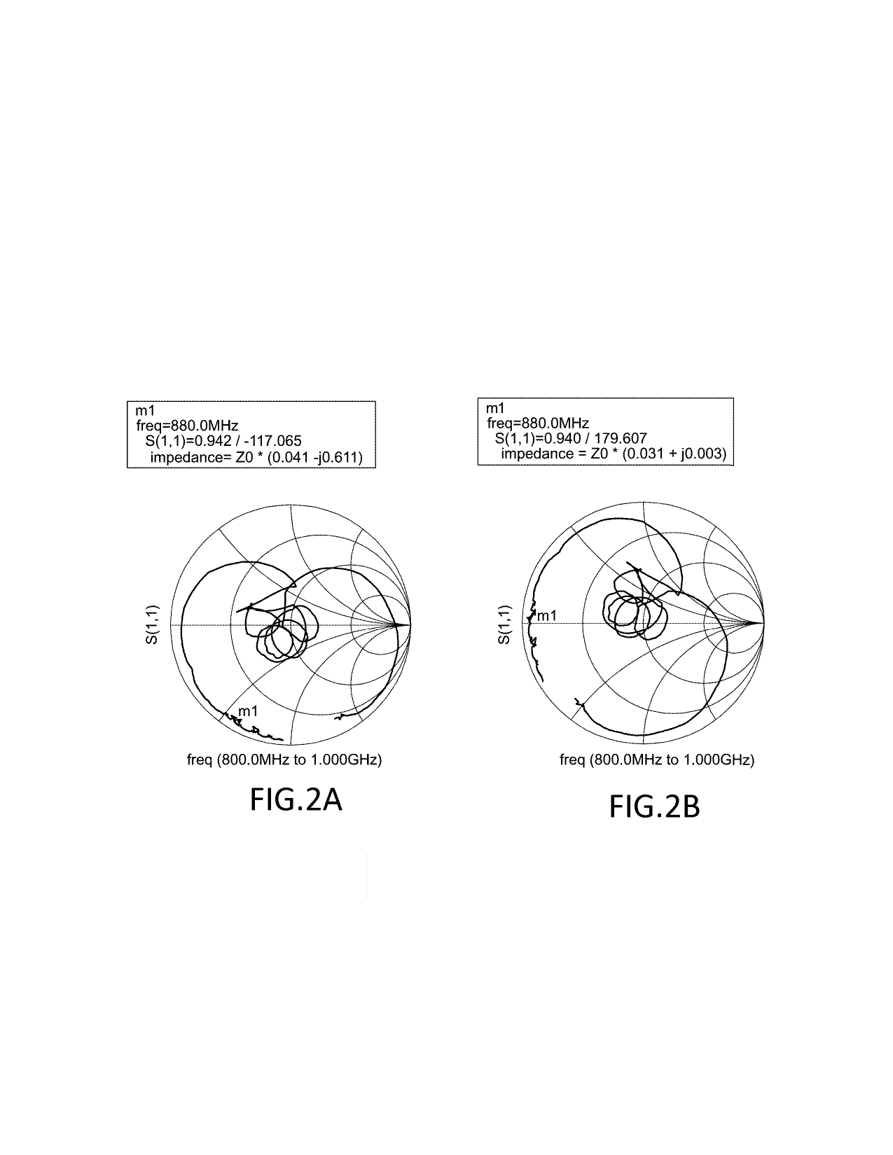

Referring to FIGS. 2A and 2B, a description will be given of the rotation of input impedance by the phase shifter 22. FIG. 2A is a Smith chart showing the frequency characteristics of input impedance as viewed from the connection point J1 of the circuit 31 as a single unit in which the phase shifter 22 is removed from the configuration shown in FIG. 1 (here, a circuit composed of the switch matching circuit 21, the band pass filter 24, the band pass filter 26, and the matching circuit 28 because of the omission of the phase shifter 22), and FIG. 2B is a Smith chart showing the frequency characteristics of input impedance as viewed from the connection point J1 of the circuit 31 as a single unit shown in FIG. 1 (a circuit composed of the switch matching circuit 21, the phase shifter 22, the band pass filter 24, the band pass filter 26, and the matching circuit 28). That is, the Smith charts of FIGS. 2A and 2B show the results of a simulation of the input impedance of the circuit 31 in a condition in which the switch 14 is disconnected from the circuit 31 so that the switch 14 does not substantially affect the input impedance of the circuit 31. In this case, the simulation was conducted by setting the pass band of the band pass filter 24 at 925 to 960 MHz allocated for the receiving of band VIII of UMTS and setting the pass band of the band pass filter 26 at 869 to 894 MHz allocated for the receiving of band V of UMTS.

In FIGS. 2A and 2B, the marker m1 indicates the frequency of the band pass filter 26 in the pass band. As shown in FIG. 2A, in the circuit 31 not provided with the phase shifter 22, the marker m1 is present in a capacitive region and, therefore, in using the front end module by connecting the switch 14 to the circuit 31, components of the band V of a received signal leak from the first terminal 16 and the second terminal 18 to the third terminal 20, causing the deterioration of the attenuation characteristics of the module. By providing the phase shifter 22 in this circuit 31, as shown in FIG. 2B, it is possible to rotate the input impedance counterclockwise so that the input impedance of the circuit 31 in the marker m1 becomes substantially zero. In this manner, by making the input impedance in the marker m1 (the pass band of the band pass filter 26) substantially zero, for a signal in the pass band of the band pass filter 26, the second terminal 18 is equivalent to that the second terminal 18 is grounded, and it is possible to suppress the leakage of a signal in the pass band of the band pass filter 26 from the first terminal 16 or the second terminal 18 to the third terminal 20. As a result of this, it is possible to sufficiently ensure the isolation between the band pass filter 24 and the band pass filter 26, and it is possible to suppress the deterioration of the attenuation characteristics of the front end module in the pass band of the band pass filter 26 during the action of the band pass filter 24.

In an embodiment, it is possible to configure the phase shifter 22 from a distributed constant element. The electrical length of this distributed constant element is determined so that the input impedance of the circuit 31 as a single unit as viewed from the connection point J1 becomes substantially zero in the pass band of the band pass filter 26. By configuring the phase shifter 22 from a distributed constant element, it is possible to rotate the input impedance to the grounding side at the frequency of the pass band of the band pass filter 26 present in a capacitive region without substantially affecting the matching condition of the band pass filter 24. It is also possible to configure the phase shifter 22 from a concentrated constant element instead of a distributed constant element.

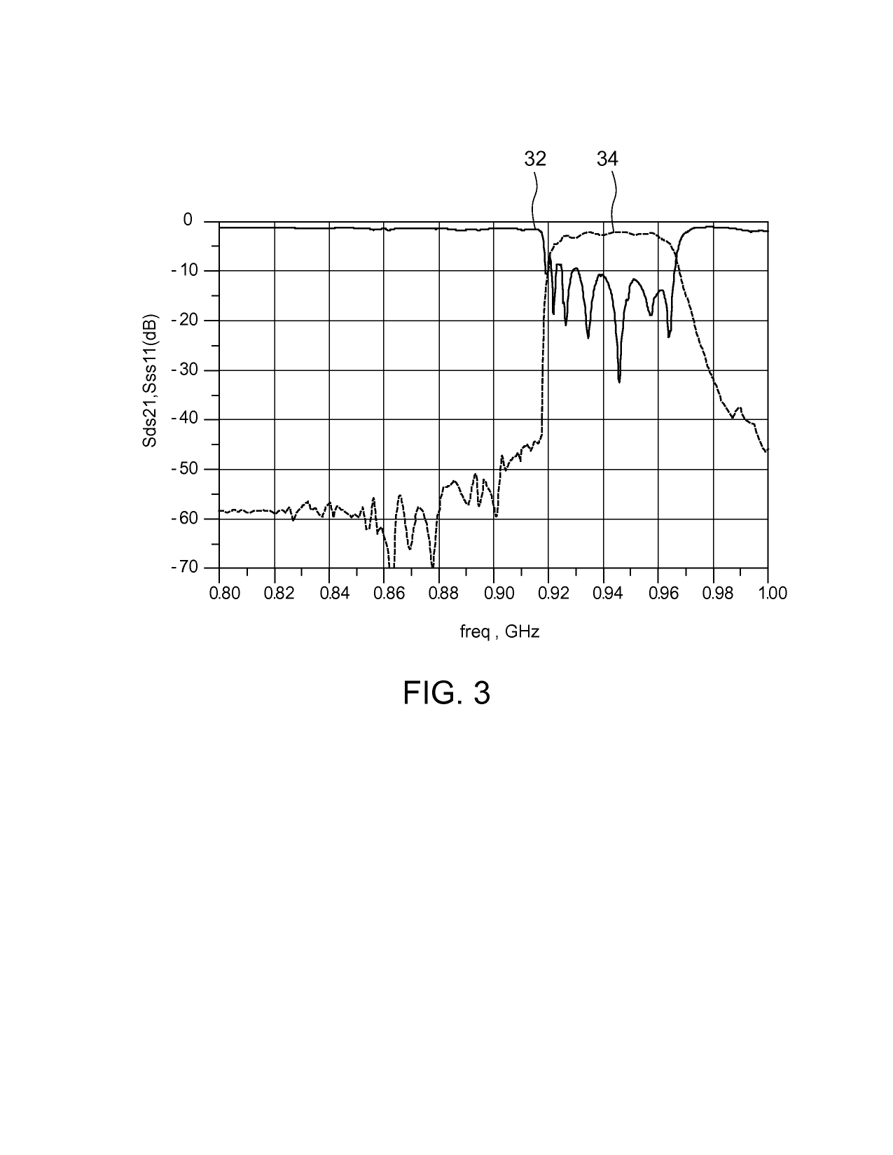

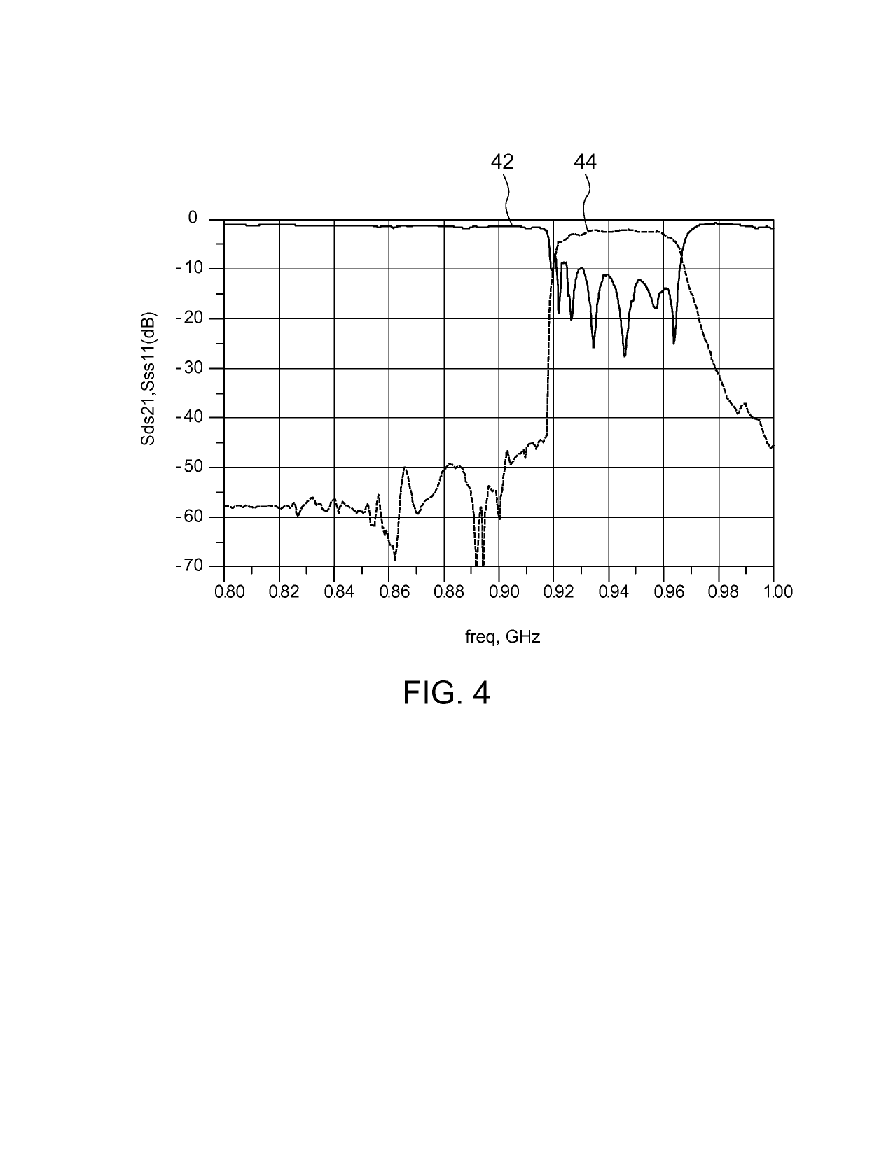

FIG. 3 is a graph showing the result of a simulation of the attenuation characteristics of a front end module in an embodiment of the present invention during the action of the band pass filter 24, and FIG. 4 is a graph showing the result of a simulation of the attenuation characteristics in the case where the band pass filter 24 is brought into action in a module obtained by removing the phase shifter 22 from the front end module 10. In this simulation, an SP8T switch was used as the switch 14 in the front end module 10 of FIG. 1 and SAW filters corresponding to the balance output of 100Ω were used as each filter. In these figures, the abscissa indicates frequency in units of GHz and the ordinate indicates the result of an evaluation of the attenuation characteristics using an S parameter of mixed mode. Specifically, the ordinate indicates the size of the Sss11 parameter indicative of the reflection characteristics on the antenna terminal side and the Sds21 parameter indicative of the attenuation characteristics in units of dB. The Sss11 parameter is denoted by reference numeral 32 or reference numeral 42, and the Sds21 parameter is denoted by reference numeral 34 or reference numeral 44. As shown in FIG. 4, in the case where the phase shifter 22 is not provided, it is apparent that the attenuation characteristics deteriorate compared to the characteristics of the band pass filter 24 as a single unit, for example, the amount of attenuation is not more than 50 dB in part of the band of 869 to 894 MHz, which is the pass band of the band pass filter 26. On the other hand, as shown in FIG. 3, in the front end module 10 in an embodiment of the present invention, all the amounts of attenuation in the band of 869 to 894 MHz are 50 dB or more, and the attenuation characteristics are improved remarkably compared to the case where the phase shifter 22 is not provided.

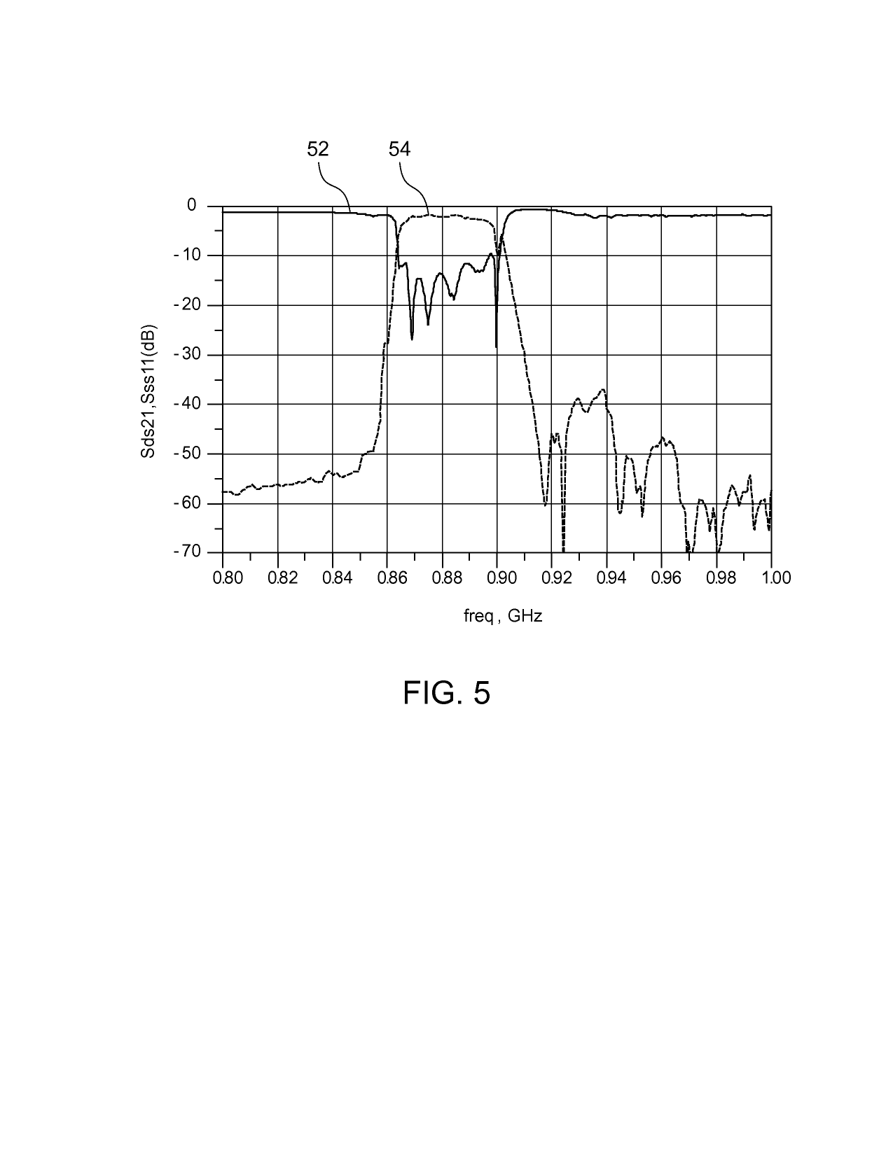

FIG. 5 is a graph showing the attenuation characteristics of the front end module 10 in the case where in the front end module 10 in an embodiment of the present invention, the band pass filter 26 is brought into action by connecting the first terminal 16 to the third terminal 20. As with FIGS. 3 (a) and 3 (b), in FIG. 5, the abscissa indicates frequency in units of GHz and the ordinate indicates the result of an evaluation of the attenuation characteristics using an S parameter of mixed mode. As shown in the figure, in the case where the band pass filter 26 is brought into action, currents are caused to pass through 869 to 894 MHz, which is the pass band of this band pass filter 26, and it is apparent that the currents outside the band are sufficiently suppressed. In this manner, even in the case where the phase shifter 22 is provided in front of the band pass filter 24, it is possible to keep the pass band of the band pass filter 26 good. In FIG. 5, slight deterioration of the amount of attenuation is observed in part of 925 to 960 MHz, which is the pass band of the band pass filter 24. However, it is possible to suppress the deterioration of this amount of attenuation by providing a phase shifter between the third terminal 20 and the band pass filter 26 by the method described below.

In an embodiment of the present disclosure, a phase shifter which is similar to the phase shifter 22 is provided between the third terminal 20 and the band pass filter 26, whereby it is possible that the input impedance of the circuit 31 as a single unit (a circuit composed of the filter matching circuit 21, the phase shifter 22, the band pass filter 24, the band pass filter 26, the matching circuit 28, and a phase shifter between the third terminal 20 and the band pass filter 26) as viewed from the connection point J2 between the third terminal 20 and the circuit 31 is made substantially zero in the pass band of the band pass filter 24. It should be noted that as described above, the evaluation of the input impedance of the circuit 31 is performed, with the effect of the switch 14 eliminated by disconnecting the switch 14 from the circuit 31. As a result of this, it is possible to prevent signals in the pass band of the band pass filter 24 from leaking from the third terminal 20 and the first terminal 16 to the second terminal 18, and it is possible to further improve the isolation between the band pass filter 24 and the band pass filter 26. This phase shifter between this third terminal 20 and the band pass filter 26 can be provided in place of the phase shifter 22 of FIG. 1 and can also be provided in addition to the phase shifter 22.

The circuit configuration of the front end module 10 shown in FIG. 1 can be appropriately changed. For example, the pass bands of the band pass filters 24, 26 described in this specification are exemplary ones and it is possible to use filters having various pass bands in place of these filters. Furthermore, the number of band pass filters which can be provided in the front end module 10 of the present invention is arbitrary, and for example, three or more band pass filters can be arranged in parallel at the rear end of the switch 14.

The front end module of the present invention can be mounted on various radio communication devices other than cellular phones. The front end module of the present invention can be miniaturized by being incorporated in an LTCC (low-temperature co-fired ceramic) multilayer circuit board.

The embodiments of the present invention are not limited to those aspects specifically described above, and the embodiments described in this specification are subject to various changes without departing from the gist of the present invention.

### REFERENCE SIGNS LIST

10 . . . Front end module, 12 . . . Antenna terminal, 14 . . . Switch, 22 . . . Phase shifter, 24, 26 . . . Band pass filter, 28 . . . Matching circuit, 30 . . . Output terminal

What is claimed is:

1. A front end module, comprising:
an antenna terminal to which a received signal from at least an antenna is inputted;
an output terminal;
a switch which has a first terminal, a second terminal, and a third terminal, is connected to the antenna terminal via the first terminal, and selectively connects the first terminal to the second terminal or the third terminal;
a first transmission channel which transmits the received signal between the second terminal and the output terminal;
a second transmission channel which transmits the received signal between the third terminal and the output terminal;
a first filter which is provided on the first transmission channel and causes a signal of a first pass band in the received signal to pass therethrough;
a second filter which is provided on the second transmission channel and causes a signal of a second pass band, which is different from the first pass band, in the received signal to pass therethrough;
a matching circuit which is arranged between the first and second filters and the output terminal; and
a first phase shifter which is arranged between the second terminal and the first filter.

2. The front end module according to claim 1, further comprising:
a second phase shifter which is arranged between the third terminal and the second filter.

3. The front end module according to claim 1, wherein an electrical length of the first phase shifter is determined so that the input impedance of a circuit including the first and second filters, the matching circuit, and the first phase shifter becomes substantially zero in the pass band of the second filter.

4. The front end module according to claim 2, wherein the electrical length of the first phase shifter is determined so that the input impedance of a circuit including the first and second filters, the matching circuit, and the first and second phase shifters becomes substantially zero in the pass band of the second filter.

5. The front end module according to claim 2, wherein the electrical length of the second phase shifter is determined so that the input impedance of a circuit including the first and second filters, the matching circuit, and the first and second phase shifters becomes substantially zero in the pass band of the first filter.

6. The front end module according to claim 1, wherein the phase shifter is composed of a distributed constant element.

7. The front end module according to claim 1, wherein the phase shifter is composed of a concentrated constant element.

8. A radio communication device comprising the front end module according to claim 1.
